(19) United States
(12) Patent Application Publication
(10) Pub. No.: US 2021/0146789 A1
(43) Pub. Date: May 20, 2021

(54) LOW VOLTAGE COMPENSATION SYSTEM FOR MICRO ELECTRIC VEHICLE

(71) Applicant: CAMMSYS Corp., Incheon (KR)

(72) Inventors: Chung Woo LEE, Suwon-si (KR); In Jae JEONG, Hwaseong-si (KR)

(21) Appl. No.: 16/717,533

(22) Filed: Dec. 17, 2019

(30) Foreign Application Priority Data
Nov. 14, 2019 (KR) 10-2019-0145852

(51) Int. Cl. B60L 50/52; B60L 50/11

(52) U.S. Cl. CPC B60L 50/52; B60L 58/18; B60L 50/11

(57) ABSTRACT

According to an embodiment of the present invention, there is provided a low voltage compensation system for a micro electric vehicle including: a motor configured to drive a micro electric vehicle; a motor control unit configured to control the motor and supply power received from a main battery to the motor; a main battery configured to supply the power to the motor control unit; and a sub battery for compensating for a voltage of the main battery. According to the present invention, it is possible to prevent an output reduction due to a low voltage of the main battery by compensating for a dropped voltage of the main battery using the sub battery when the voltage of the main battery is dropped below a reference value by adding the sub battery in addition to the main battery, thereby efficiently and stably operating the micro electric vehicle.

### CROSS-REFERENCE TO RELATED APPLICATION

This application claims under 35 U.S.C. § 119(a) the benefit of Korean Patent Application No. 10-2019-0145852 filed on Nov. 14, 2019, the entire contents of which are incorporated herein by reference.

### BACKGROUND

### (a) Technical Field

The present invention relates to a low voltage compensation system for a micro electric vehicle and more particularly, to a low voltage compensation system for a micro electric vehicle for compensating for a dropped voltage of a main battery using a sub battery when the voltage of the main battery of the micro electric vehicle is dropped below a reference value.

### (b) Background Art

The demand of electric vehicles (EV) has been continuously increased due to gradual depletion of fossil fuels and exhaust of carbon dioxide (CO2) from exhaust gas of general internal-combustion engine vehicles. The electric vehicle has used an electric driving motor operated by electric energy stored in a battery to provide the power to the vehicle.

Meanwhile, among the electric vehicles, an electric vehicle which has a smaller size than existing electric vehicles and carries 1 to 2 passengers is classified into a micro electric vehicle.

In the case of the micro electric vehicle, traveling of about 100 km is possible with once charging and a maximum speed is possible up to about 60 km to 80 km per hour. In addition, the micro electric vehicle has been recently in the spotlight as a new small transportation because the price thereof is much cheaper than those of conventional electric vehicles.

However, in the case of such a micro electric vehicle, most about 70 V of a main battery is used, but when the main battery is fully charged, the voltage is about 82 V and when the main battery is fully discharged, the voltage is about 60 V. The voltages during full charge and full discharge are changed to be close to 25%, and while a residual capacity of the main battery is less than 30%, the voltage is less than 70 V and thus there is a problem that there is a limitation on an output of a motor.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art and to provide a low voltage compensation system for a micro electric vehicle which compensates for a dropped voltage of a main battery using a sub battery when the voltage of the main battery is dropped below a reference value by adding the sub battery in addition to the main battery.

According to a preferred embodiment of the present invention, there is provided a low voltage compensation system for a micro electric vehicle including: a motor configured to drive a micro electric vehicle; a motor control unit configured to control the motor and supply power received from a main battery to the motor; a main battery configured to supply the power to the motor control unit; and a sub battery for compensating for a voltage of the main battery.

The sub battery may include a sub battery cell for supplying the power; a first switch connected with the sub battery cell in parallel; a backflow prevention circuit connected with the sub battery cell and the first switch in parallel; a second switch connected between one end of the backflow prevention circuit and a negative electrode of the sub battery cell; a third switch connected between the motor control unit and the negative electrode of the sub battery cell; and a fourth switch connected between a negative electrode of the main battery and a positive electrode of the sub battery cell.

When the voltage of the main battery is equal to or greater than a reference voltage, the first switch may be maintained in an ON state; the second switch may be maintained in an OFF state; the third switch may be maintained in an OFF state; the fourth switch may be maintained in an OFF state; and the fifth switch may be maintained in an OFF state.

When the voltage of the main battery is equal to or lower than the reference voltage, the system may include: (a) converting the second switch and the third switch to the ON state; (b) converting the first switch to the OFF state; (c) converting the fourth switch to the ON state; and (d) converting the second switch to the OFF state.

The low voltage compensation system for the micro electric vehicle may include an OBC for charging the main battery; an LDC for charging the sub battery cell; and a fifth switch connected between the sub battery cell and the LDC.

When the main battery is in a charge mode, the fifth switch may be converted to the ON state, and the sub battery cell may be charged by the LDC.

According to the present invention, it is possible to prevent an output reduction due to a low voltage of the main battery by compensating for a dropped voltage of the main battery using the sub battery when the voltage of the main battery is dropped below a reference value by adding the sub battery in addition to the main battery, thereby efficiently and stably operating the micro electric vehicle.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram schematically illustrating a configuration of a low voltage compensation system for a micro electric vehicle according to an embodiment of the present invention;

FIG. 2 is a diagram schematically illustrating a configuration of a sub battery according to an embodiment of the present invention; and

FIG. 3 is a flowchart for describing an operating method of a low voltage compensation system for a micro electric vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, reference will now be made in detail to various embodiments of the present disclosure, examples of which are illustrated in the accompanying drawings and described below.

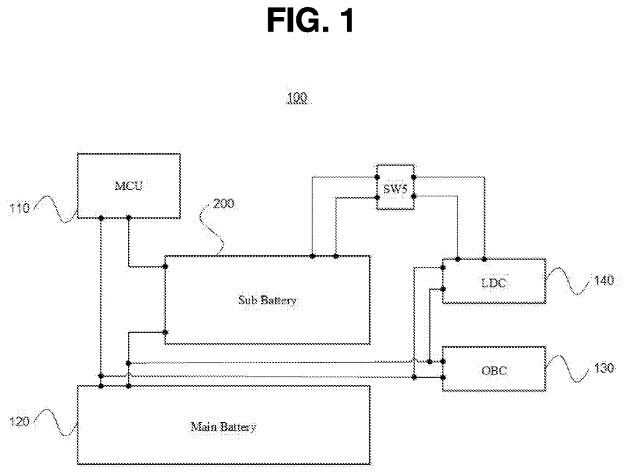

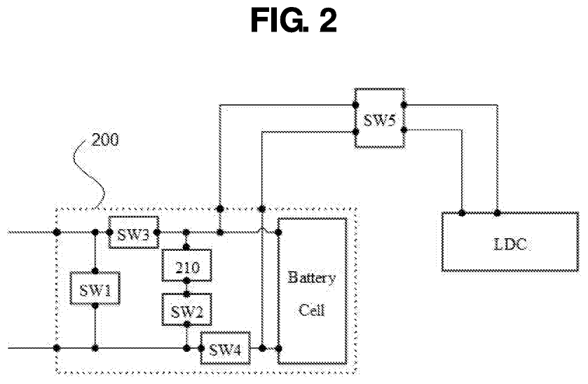

FIG. 1 is a diagram schematically illustrating a configuration of a low voltage compensation system for a micro electric vehicle according to an embodiment of the present invention and FIG. 2 is a diagram schematically illustrating a configuration of a sub battery according to an embodiment of the present invention.

Referring to FIGS. 1 and 2, a low voltage compensation system 100 for a micro electric vehicle according to an embodiment of the present invention includes a motor (not illustrated) driving the micro electric vehicle, a motor control unit (MCU) 110 controlling the motor and supplying power received from a main battery to the motor, a main battery 120 supplying the power to the MCU, a sub battery 200 for compensating for the voltage of the main battery, an on-board charger (OBC) 130 for charging the main battery, and a low voltage DC-DC converter (LDC) 140 for charging the sub battery.

The motor is to drive the micro electric vehicle and generally, divided into an AC motor or a DC motor, and in the micro electric vehicle, generally, the AC motor is used. The AC motor converts direct current (DC) power transmitted from the main battery 120 to alternating current (AC) power through the MCU 110 to be driven. Accordingly, the AC motor requires a precise control through the MCU 110, but has advantages of having a small size, a light weight, high efficiency, and no brush to increase the number of rotation as compared to the DC motor.

The MCU 110 serves to control the motor. The MCU 110 controls a torque, a speed, and a generation torque quantity of the motor. Further, the MCU 110 serves as an inverter which applies the output voltage of the main battery 120 to the motor and converts the DC power received from the main battery 120 to the AC power and then supplies the power to the motor to control the motor such as a torque and a speed of the motor.

The main battery 120 is an energy storage device which supplies the power for driving the motor of the micro electric vehicle, and in a general electric vehicle, a high capacity battery pack having a large electric energy used amount at a high voltage of rating 360 V or more is applied, but in the micro electric vehicle, a low capacity battery pack of most about 70 V is applied. The battery pack of the main battery 120 may include as many as tens of battery cells, and in order to safely and efficiently manage several battery cells, the battery cells are mounted on the electric vehicle in a form of the battery pack. That is, the battery cells are bound in several bundles to make a battery module, and the battery modules are bound in several bundles to be mounted on the electric vehicle in a form of the battery pack.

In the battery pack of the main battery 120, a battery management system (BMS) may be further included for an operation of the micro electric vehicle.

The BMS detects an overall state such as a voltage, a current, and a temperature of the battery cell to control estimation of a state of charge (SOC), calculation of a real-time available output, cell balancing, relay on/off, etc. One BMS may manage the battery pack and is configured by a sub. BMS per battery module and a top master BMS.

The BMS calculates an available output of the battery pack according to an SOC and a temperature to transmit the calculated available output to the MCU or the sub battery 200, so that optimal power management is enabled.

The OBC 130 as a charger mounted on the micro electric vehicle is a kind of power conversion controller which receives electric energy from an external energy source to charge the main battery 120 in the vehicle and converts the supplied AC power to the DC power.

The LDC 140 is an intensive low voltage DC-DC converter capable of charging a low voltage battery for operating low voltage system of electronics in the electric vehicle or the micro electric vehicle, and the LDC 140 is electrically connected with the sub battery 200 to charge a sub battery cell of the sub battery 200 with an output of the LDC 140.

That is, when a fifth switch SW5 is connected between the LDC 140 and the sub battery cell and the main battery 120 is in a charge mode, the fifth switch SW5 is converted to an ON state to charge the sub battery cell by the output of the LDC 140.

When the voltage of the main battery 120 of the micro electric vehicle is below a reference voltage, the sub battery 200 is connected to the main battery 10 in series to compensate for a voltage drop of the main battery 120.

The main battery 120 of the micro electric vehicle uses the battery pack of about 70 V, and in the case of the battery pack of about 70 V, the voltage during full charge is about 82 V and the voltage during full discharge is about 60 V. Such a voltage range is a change rate corresponding to 25% of the overall voltage, and when the SOC of the main battery 120 is less than 30%, the voltage of the main battery 120 is in a low voltage state of less than about 70 V, so that a limitation on the output of the motor occurs.

In the case where the voltage of the main battery 120 is below the reference voltage, when the main battery 120 and the sub battery 200 are connected to each other in series, the voltage applied to the MCU 110 may be applied as a voltage obtained by adding the voltage of the sub battery 200 to the voltage of the main battery 120 in the low voltage state. Accordingly, it is possible to solve limitations of the output and the climbing of the motor which may occur due to the voltage of the main battery 120 in the low voltage state.

The sub battery 200 includes a sub battery cell for supplying the power, a first switch SW1 connected with the sub battery cell in parallel, a backflow prevention circuit connected with the sub battery cell and the a first switch SW1 in parallel, a second switch SW2 connected between one end of the backflow prevention circuit and a negative electrode of the sub battery 200, a third switch SW3 connected between the MCU 110 and a negative electrode of the sub battery cell, and a fourth switch SW4 connected between a negative electrode of the main battery 120 and a positive electrode of the sub battery cell. Here, so long as a power line located with each switch may be converted to an active state or an inactive state, each switch may use any type of switch, but generally, may use a relay switch or an FET switch.

The first switch SW1 is connected with the sub battery cell in parallel, and when the first switch SW1 is in an ON state, the first switch SW1 bypasses the sub battery cell, and thus the power output from the main battery 120 flows through the power line of the first switch SW1.

A reverse current prevention circuit 210 is to prevent a current flowing in reverse and is able to be used without limitation to a type or a configuration of the circuit so long as achieving the object. The reverse current prevention circuit 210 is connected with the sub battery cell and the first switch SW1 in parallel and the second switch SW2 is connected between one end of the backflow prevention circuit and the negative electrode of the sub battery 200. Then, in the state of each switch in the sub battery 200, when the first switch SW1 is in an OFF state, the second switch SW2 is in an ON state, the third switch SW3 is in the ON state, and the fourth switch SW4 is in the OFF state, the power output from the main battery 120 flows through the power line of the reverse current prevention circuit 210 and the current flowing in reverse is prevented so as not to flow in an opposite direction.

The third switch SW3 is connected between the MCU 110 and the negative electrode of the sub battery cell and the fourth switch SW4 is connected between the negative electrode of the main battery 120 and the positive electrode of the sub battery cell. Then, in the state of each switch in the sub battery 200, when the first switch SW1 is in an OFF state, the second switch SW2 is in the OFF state, the third switch SW3 is in an ON state, and the fourth switch SW4 is in the ON state, the main battery 120 and the sub battery 200 are connected to each other in series and then the power output from the sub battery cell is added to the power output from the main battery 120 to be applied to the MCU 110. As a result, the voltage obtained by adding the voltage of the sub battery 200 to the voltage of the main battery 120 in the low voltage state is applied to the MCU 110 to solve the limitation of the output and the climbing of the motor which may occur due to the voltage of the main battery 120 in the low voltage state.

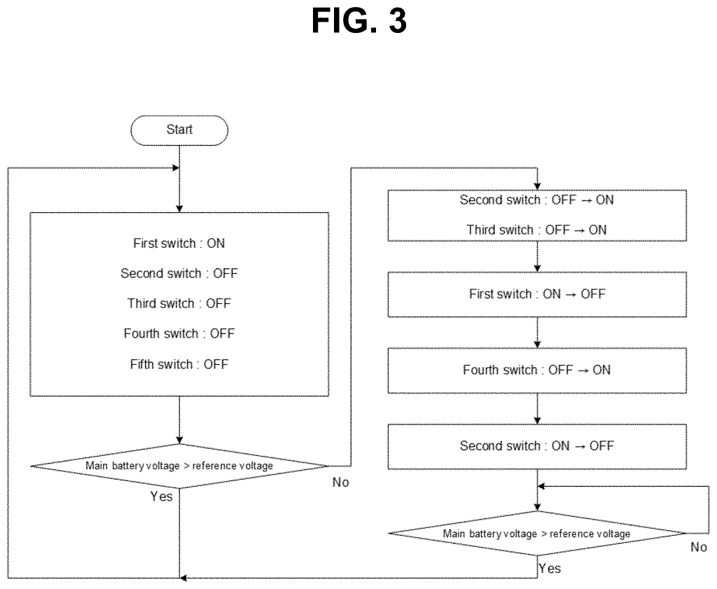

FIG. 3 is a flowchart for describing an operating method of a low voltage compensation system for a micro electric vehicle according to an embodiment of the present invention.

Referring to FIG. 3, in an operating method of the low voltage compensation system for the micro electric vehicle, an operation starts while the first switch SW1 is in the ON state, the second switch SW2 is in the OFF state, the third switch SW3 is in the OFF state, the fourth switch SW4 is in the OFF state, and the fifth switch SW5 is in the OFF state in the state of each switch. When the low voltage compensation system for the micro electric vehicle is operated, in the case where the voltage of the main battery 120 is above the reference voltage, the state of each switch is continuously maintained, so that the power output from the main battery 120 flows through the power line of the first switch SW1 and the sub battery cell maintains in the inactive state.

When the voltage of the main battery 120 is below the reference voltage, that is, the main battery 120 is determined as the low voltage state, through steps of (a) converting the second switch SW2 and the third switch SW3 to the ON state, (b) converting the first switch SW1 to the OFF state, (c) converting the fourth switch SW4 to the ON state, and (d) converting the second switch SW2 to the OFF state, the sub battery 200 is connected to the main battery 120 in series to compensate for the voltage drop of the main battery 120.

First, through the step of converting the second switch SW2 and the third switch SW3 to the ON state, while the power line of the first switch SW1 is activated, the power line of the reverse current prevention circuit 210 and the power line of the second switch SW2 are activated. At this time, the power output from the main battery 120 flows through the power line of the first switch SW1 and the power line of the reverse current prevention circuit 210 and the sub battery cell maintains the inactive state.

Next, through the step of converting the first switch SW1 to the OFF state, the power line of the first switch SW1 is converted to the inactive state, the power output from the main battery 120 flows through the power line of the reverse current prevention circuit 210, the current flowing in reverse is prevented so as not to flow in an opposite direction, and the sub battery cell maintains the inactive state.

Next, through the step of converting the fourth switch SW4 to the ON state, the sub battery cell is converted to the active state and converted to a state connected to the main battery 120 in series, and the reverse current prevention circuit 210 prevents the current flowing in reverse so that the current does not flow in an opposite direction.

Next, through the step of converting the second switch SW2 to the OFF state, the power line of the reverse current prevention circuit 210 is converted to the inactive state, and as a result, the main battery 120 and the sub battery 200 are connected to each other in series and then the power output from the sub battery cell is added to the power output from the main battery 120 to be applied to the MCU 110. That is, the voltage obtained by adding the voltage of the sub battery 200 to the voltage of the main battery 120 in the low voltage state is applied to the MCU 110 to solve the limitation of the output and the climbing of the motor which may occur due to the voltage of the main battery 120 in the low voltage state.

Meanwhile, in the operating method of the low voltage compensation system for the micro electric vehicle, for the stabilization of a vehicle driving system, the system may be operated when the vehicle is stopped, that is, when the RPM of the motor is 0 or ignition is turned on.

According to the low voltage compensation system for the micro electric vehicle of the present invention, it is possible to prevent an output reduction due to a low voltage of the main battery by compensating for a dropped voltage of the main battery using the sub battery when the voltage of the main battery is dropped below a reference value by adding the sub battery in addition to the main battery to the micro electric vehicle, thereby efficiently and stably operating the micro electric vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A low voltage compensation system for a micro electric vehicle comprising:
a motor configured to drive a micro electric vehicle;
a motor control unit configured to control the motor and supply power received from a main battery to the motor;
a main battery configured to supply the power to the motor control unit; and
a sub battery for compensating for a voltage of the main battery.

2. The low voltage compensation system for the micro electric vehicle of claim 1, wherein the sub battery includes:
a sub battery cell for supplying the power;
a first switch connected with the sub battery cell in parallel;
a backflow prevention circuit connected with the sub battery cell and the first switch in parallel;
a second switch connected between one end of the backflow prevention circuit and a negative electrode of the sub battery cell;
a third switch connected between the motor control unit and the negative electrode of the sub battery cell; and
a fourth switch connected between a negative electrode of the main battery and a positive electrode of the sub battery cell.

3. The low voltage compensation system for the micro electric vehicle of claim 2, wherein when the voltage of the main battery is equal to or greater than a reference voltage,
the first switch is maintained in an ON state;
the second switch is maintained in an OFF state;
the third switch is maintained in an OFF state;
the fourth switch is maintained in an OFF state; and
the fifth switch is maintained in an OFF state.

4. The low voltage compensation system for the micro electric vehicle of claim 2, wherein when the voltage of the main battery is equal to or lower than the reference voltage, the system includes:
(a) converting the second switch and the third switch to the ON state;
(b) converting the first switch to the OFF state;
(c) converting the fourth switch to the ON state; and
(d) converting the second switch to the OFF state.

5. The low voltage compensation system for the micro electric vehicle of claim 1, comprising:
an OBC for charging the main battery;
an LDC for charging the sub battery cell; and
a fifth switch connected between the sub battery cell and the LDC.

6. The low voltage compensation system for the micro electric vehicle of claim 5, wherein when the main battery is in a charge mode, the fifth switch is converted to the ON state, and the sub battery cell is charged by the LDC.
